(19) United States
(12) Patent Application Publication
(10) Pub. No.: US 2003/0167695 A1
(43) Pub. Date: Sep. 11, 2003

(54) Dual-arm window regulator

(76) Inventors: Luc Roger Regnier, Toronto (CA); Ken C. Borchuk, Westport (CA); Michelle Beckerman, Westport (CA)

Correspondence Address: Robin W. Asher, Clark Hill PLC, Suite 3500, 500 Woodward Avenue, Detroit, MI, 48226-3435, US

(21) Appl. No.: 10/353,282

(22) Filed: Jan. 28, 2003

Related U.S. Application Data
(60) Provisional application No. 60/351,423, filed on Jan. 28, 2002.

(51) Int. Cl. E05F 15/16

(52) U.S. Cl. 49/351; 49/350; 49/349; 49/348

(57) ABSTRACT

A window regulator for operating a window pane includes an attachment channel configured for attachment to the window pane, a regulator base plate, a pair of sector gears, and a drive motor. Each sector gear includes a plurality of external gear teeth, and a lift arm slidingly coupled to the attachment channel. The sector gears are rotatably coupled to the base plate and are disposed such that the gear teeth of one of the sector gears directly engage the gear teeth of the other sector gears. The drive motor is in direct engagement with one of the sector gears. Consequently, rotation of the drive pinion of the drive motor causes the sector gears to rotate in opposing directions and the lift arms to either raise or lower the window pane.

### FIELD OF THE INVENTION

The present invention relates to a window regulator for a vehicle window. In particular, the present invention relates to a power window regulator having a pair of drive arms for driving a vertically slidable window of a vehicle between its open and closed positions.

### BACKGROUND OF THE INVENTION

The conventional window regulator for the rear window of a vehicle, such as that disclosed by Pickles in U.S. Pat. No. 3,659,466, consists of a mounting plate, a pair of sector gears pivotally connected to the mounting plate, and a drive mechanism coupled to one of the sector gears. The mounting plate includes an opening having a number of internal gear teeth. The sector gears include external gear teeth, and are coupled to the mounting plate such that the sector gears mesh with one another and rotation of one of the sector gears imparts an opposite rotation to the other sector gear. Each sector gear also includes a lift arm coupled to the window pane which is used to drive the window pane between an upper and a lower position.

The drive mechanism consists of a sun gear and a number of planetary gears disposed within the mounting plate opening. The planetary gears are disposed around and in engagement with the sun gear. The planetary gears are also in engagement with the internal gear teeth of the mounting plate opening, and mounted on a drive plate which is secured to one of the sector gears. The drive mechanism also includes a pinion coupled to the sun gear, and a hand crank coupled to the pinion. Consequently, when the hand crank is rotated in one direction, the planetary gears rotate about the sun gear, causing the lift arms to rotate in away from one another and the window pane to move in a vertical direction. When the hand crank is rotated in the opposite direction, the lift arms will rotate towards one another, causing the window pane to move in an opposite vertical direction.

As will be apparent, the complexity and number of components comprising the drive mechanism add to the manufacturing and assembly cost of the conventional window regulator. Accordingly, attempts have been made to reduce the complexity of the conventional window regulator. One such window regulator, disclosed by Cook in U.S. Pat. No. 4,119,341, consists of a pair of channel members secured to the lowermost portion of the window pane, a pair of sector gears, and a drive mechanism coupled to the sector gears. Each sector gear is fitted with an elongate drive arm having a roller for engaging a respective channel. The drive mechanism consists of an electric motor, a reduction gear set coupled to the electric motor, and a pair of pinion gears each coupled to the reduction gear set and engaging the gear teeth of a respective sector gear.

The electric motor is powered by an electrical accessory sub-system of the vehicle, and is controlled by a suitable switch, typically located within the vehicle. When the electric motor is commanded by the switch to rotate in one direction, the sector gears will rotate in opposite directions to one another, and the drive arms will move away from each other, causing the window pane to move downwards into the open position. When the electric motor is commanded by the switch to rotate in the opposite direction, the drive arms will move towards one another, causing the window pane to move upwards into the closed position.

Although the solution taught by Cook reduces the component count for the window regulator, the component count and manufacturing/assembly cost is still unnecessarily high. Therefore, there remains a need for an improved window regulator for operating a vehicle window.

### SUMMARY OF THE INVENTION

According to the present invention, there is provided a window regulator for operating a window pane. According to a first aspect of the invention, the window regulator includes an attachment channel configured for attachment to the window pane, a regulator base plate, a pair of sector gears, and a drive motor. Each sector gear includes a plurality of external gear teeth, and a lift arm slidingly coupled to the attachment channel. The sector gears are rotatably coupled to the base plate and are disposed such that the gear teeth of one of the sector gears directly engage the gear teeth of the other sector gears. The drive motor is in direct engagement with one of the sector gears. Consequently, rotation of the drive pinion of the drive motor causes the sector gears to rotate in opposing directions and the lift arms to either raise or lower the window pane.

According to a second aspect of the invention, the window regulator includes a window pane attachment member configured for attachment to the window pane, a pair of sector gears, and a drive motor in direct engagement with one of the sector gears. Each sector gear includes a plurality of external gear teeth, and a lift arm slidingly coupled to the attachment member. The sector gears have a respective axis of rotation displaced from one other such that the gear teeth of one of the sector gears directly engage the gear teeth of the other sector gears.

According to a third aspect of the invention, the window regulator includes a window pane attachment member configured for attachment to the window pane, a pair of intermeshing sector gears disposed for rotation in opposing directions relative to one another, and a drive motor. Each sector gear includes a respective lift arm slidingly coupled to the attachment member, with one of the sector gears including a plurality of gear teeth. The drive motor includes a drive pinion which meshes with the gear teeth of the one sector gear.

A fourth aspect of the invention relates to a vehicle having one of the aforesaid window regulators.

### BRIEF DESCRIPTION OF THE DRAWINGS

The present invention will now be described, by way of example only, with reference to the accompanying drawings, in which:

FIG. 1 is an end elevation of a rear window of a vehicle fitted with a window regulator according to one preferred embodiment, depicting a window pane attachment channel, lift arms of sector gears, and a drive motor; and

FIG. 2 is a magnified perspective view of a window regulator according to a second preferred embodiment, depicting a regulator base plate, the sector gears, and a drive pinion of the drive motor.

### DETAILED DESCRIPTION OF PREFERRED EMBODIMENTS

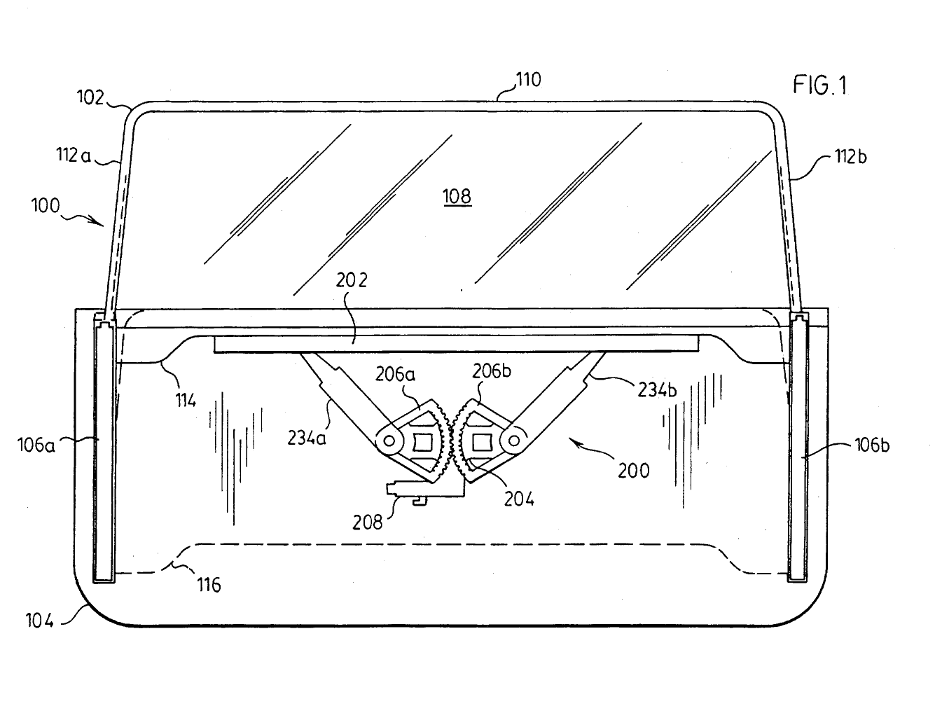

FIG. 1 depicts the rear portion of a vehicle 100, such as a station wagon or truck cab. The vehicle 100 includes a window frame 102, an upright panel 104 disposed below the window frame 102, a pair of upright guide channels 106a, 106b, and a window pane 108. The window frame 102 defines a window opening, and comprises a top end channel 110, and a pair of side channels 112a, 112b aligned and integral with the top end channel 110.

The upright panel 104 is disposed below the window frame 102, and extends substantially the width of the rear of the vehicle 100. The guide channels 106 are secured to the upright panel 104, and are each aligned with a respective side channel 112. The guide channels 106 and the side channels 112 are sized to allow the window pane 108 to move vertically between a closed position 114, in which the window pane 108 closes the window opening, and an opened position 116 (shown in phantom), in which the window pane 108 is disposed below and exposes the window opening.

FIG. 1 also depicts a window regulator 200 for moving the window pane 108 between the closed position 114 and the opened position 116. The window regulator 200 includes a window pane attachment member 202, a regulator base plate 204, a pair of intermeshing sector gears 206a, 206b, and a drive motor 208. The attachment member 202 is secured to the lowermost edge of the window pane 108, and includes an elongate U-shaped channel extending a substantial portion of the width of the window pane 108.

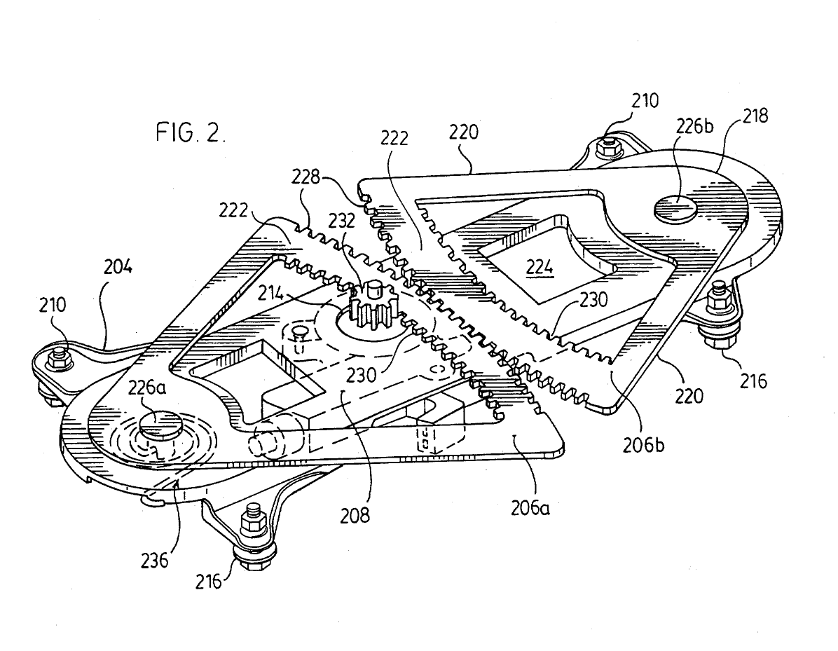

As seen in FIG. 2, the regulator base plate 204 comprises a substantially planar metal plate, and includes a number of mounting through-holes 210, a pair of axle holes, and an enlarged aperture 214 disposed centrally of the axle holes. The mounting through-holes 210 are sized to receive mounting screws 216 for securing the base plate 204 vertically to the upright panel 104.

The sector gears 206 are each stamped from substantially planar sheet metal, and are made identical to one another to thereby reduce the manufacturing costs for the window regulator 200. Each sector gear includes a vertex portion 218, a pair of sector arms 220 extending from the vertex portion 218, and an arcuate gear portion 222 extending between the sector arms 220. Preferably, each sector gear includes an open portion 224 defined between the vertex 218, the sector arms 220 and the gear portion 222, however, in one variation discussed below, the sector gears 206 do not include the open portion 224.

The vertex portion 218 includes an axle 226 configured to be received within a respective axle hole. The axle holes and the axles 226 provide each sector gear 206 with a respective axis of rotation which allow each sector gear 206 to rotate relative to the base plate 204. Alternately, in one variation, the sector gears each include an axle hole (in replacement of the axle 226), and the regulator base plate 204 includes a pair of pins (in replacement of the axle holes) sized to be received within a respective axle hole to allow the sector gear 206 to rotate relative to the base plate 204.

The arcuate gear portion 222 includes a number of external gear teeth 228. As shown, the axes of rotation of the sector gears 206 are displaced from one other along the base plate 204 such that the external gear teeth 228 of one of the sector gears 206 directly-engage the external gear teeth 228 of the other sector gear 206. In the variation where the sector gears 206 include the open portion 224, preferably the arcuate gear portion 222 also includes a number of internal gear teeth 230 extending radially into the open portion 224 towards the vertex portion 218.

The drive motor 208 comprises an electric motor which is powered by one of the electrical accessory sub-systems of the vehicle 100. As shown in FIG. 2, the drive motor 208 is secured to the base plate 204, and includes a drive pinion 232 which extends through the enlarged aperture 214 of the base plate 204 and engages one of the sector gears 206a. With this arrangement, the drive pinion 232 drives the sector gear 206a which in turn drives the other sector gear 206b.

In the implementation shown in FIG. 2, the drive pinion 232 meshes directly with the internal gear teeth 230 of the sector gear 206a, whereas in the variation shown in FIG. 1, the sector gears 206 do not include the open portion 224, and the drive pinion 232 engages the external gear teeth 228 of the sector gear 206a. As will be appreciated, in this variation, the drive pinion 232 is displaced sufficiently from the pitch point of the sector gears 206 to allow the sector gears 206 to rotate.

The sector gears 206 also include respective lift arms 234a, 234b which, as described in greater detail below, serve to raise and lower the window pane 108 as the sector gears 206 rotate. To reduce the load on the drive motor 208 as the lift arms 234 raise the window pane 108, preferably the window regulator 200 includes a coil spring 236 secured at one end to the base plate 204 and secured at the opposite end to the vertex portion 218 of the driven sector gear 206a. The coil spring may be applied in the alternative or in addition to the other sector gear 206b.

Each lift arm 234 extends from the vertex portion 218 of the respective sector gear 206, and is radially aligned with the axis rotation of the sector gear 206. Preferably, the lift arm 234 is fabricated separately from the vertex portion 218, the sector arms 220 and the gear portion 222, and is secured to the vertex portion 218. However, the lift arm 234 may also be stamped integrally with the vertex portion 218, if desired. Each lift arm 234 includes a roller pin configured for receipt within the U-shaped channel of the attachment member 202 or a slot formed therein, thereby slidingly coupling the lift arm 234 to the attachment member 202.

In operation, the vehicle occupant actuates the drive motor 208 through a suitable control switch, thereby causing one of the sector gears 206 to rotate about its respective axis of rotation. Since the external gear teeth 228 of the driven sector gear 206 meshes with the external gear teeth 228 of the other sector gear 206, both sector gears 206 rotate in opposite directions relative to one another. Consequently, when the drive pinion 232 of the drive motor 208 rotates in one direction, the lift arms 234 will lower the window pane 108 from the closed position 114 to the opened position 116. Conversely, when the drive pinion 232 rotates in the opposite direction, the lift arms 234 will raise the window pane 108 the opened position 116 to the closed position 114.

The foregoing description is illustrative of the preferred embodiments of the invention. Those of ordinary skill may envisage other additions, deletions and/or modifications to the described embodiments that, although not explicitly suggested herein, do not depart from the spirit of the invention.

We claim:

1. A window regulator for operating a window pane, the window regulator comprising:
an attachment member for mounting the window pane;
a regulator base plate;
first and second sector gears, each sector gear including a plurality of external gear teeth and a lift arm slidingly coupled to the attachment member, wherein the sector gears are rotatably coupled to the base plate and disposed such that the external gear teeth of the first sector gear engages directly the external gear teeth of the second sector gear; and
a drive motor engaging directly the first sector gear.

2. A window regulator according to claim 1, wherein the first sector gear includes an opening having internal gear teeth, and the drive motor engages the internal teeth.

3. A window regulator according to claim 2, wherein the drive motor includes a pinion gear that meshes with said internal gear teeth.

4. A window regulator according to claim 1, wherein the drive motor engages the external teeth of the first sector gear.

5. A window regulator according to claim 4, wherein the drive motor includes a pinion gear that meshes with the external teeth of the first sector gear.

6. A window regulator according to claim 1, including a coil spring operatively connected between the base plate and at least one of the sector gears.

7. A window regulator for operating a window pane, the window regulator comprising:
an attachment member for mounting the window pane thereon;
first and second sector gears, each sector gear including a plurality of external gear teeth and including a lift arm slidingly coupled to the attachment member, the sector gears each having a respective axis of rotation displaced one from another such that the external gear teeth of the first sector gear directly engages the external gear teeth of the second sector gear; and
a drive motor in direct engagement with the first sector gear.

8. A window regulator according to claim 7, wherein the first sector gear includes an opening having internal gear teeth, and the drive motor engages the internal teeth.

9. A window regulator according to claim 8, wherein the drive motor includes a pinion gear that meshes with said internal gear teeth.

10. A window regulator according to claim 7, wherein the drive motor engages the external teeth of the first sector gear.

11. A window regulator according to claim 10, wherein the drive motor includes a pinion gear that meshes with the external teeth of the first sector gear.

12. A window regulator according to claim 7, including a coil spring operatively connected between the base plate and at least one of the sector gears.

13. A window regulator for operating a window pane, the window regulator comprising:
an attachment member for mounting the window pane thereon;
a pair of intermeshing sector gears disposed for rotation in opposing directions relative to one another, each said sector gear including a respective lift arm slidingly coupled to the attachment member, one of the sector gears including a plurality of gear teeth; and
a drive motor having a drive pinion meshing with the gear teeth of the one sector gear.

14. A vehicle, comprising:
a window pane;
a panel having a first pair of opposed channels;
a window frame having a second pair of opposed channels that are aligned with the first pair of channels so as to enable the window pane to slide simultaneously in the first and second pair of channels;
a window regulator for sliding the window pane between an open position wherein the window pane is substantially disposed in the panel and a closed position wherein the window pane is substantially disposed in the window frame, the window regulator comprising:
an attachment member for mounting the window pane;
a regulator base plate mounted to the panel;
first and second sector gears, each sector gear including a plurality of external gear teeth and a lift arm slidingly coupled to the attachment member, wherein the sector gears are rotatably coupled to the base plate and disposed such that the external gear teeth of the first sector gear engages directly the external gear teeth of the second sector gear; and
a drive motor engaging directly the first sector gear.

15. A vehicle according to claim 14, wherein the first sector gear includes an opening having internal gear teeth, and the drive motor engages the internal teeth.

16. A vehicle according to claim 15, wherein the drive motor includes a pinion gear that meshes with said internal gear teeth.

17. A vehicle according to claim 14, wherein the drive motor engages the external teeth of the first sector gear.

18. A vehicle according to claim 17, wherein the drive motor includes a pinion gear that meshes with the external teeth of the first sector gear.

19. A vehicle according to claim 14, including a coil spring operatively connected between the base plate and at least one of the sector gears.

20. A vehicle according to claim 14, wherein the drive motor is mounted to the base plate.
